(19) United States
(12) Patent Application Publication
(10) Pub. No.: US 2014/0027985 A1
(43) Pub. Date: Jan. 30, 2014

(54) SHAFT SEAL ARRANGEMENT

(71) Applicant: Gesinus Mateman, Hengelo (NL)

(72) Inventor: Gesinus Mateman, Hengelo (NL)

(21) Appl. No.: 14/110,468

(22) PCT Filed: Mar. 26, 2012
(86) PCT No.: PCT/EP2012/055274

§ 371 Date: Oct. 8, 2013

(30) Foreign Application Priority Data
Apr. 8, 2011 (DE) 10 2011 007 073.7

(51) Int. Cl. F16J 15/447

(52) U.S. Cl. CPC F16J 15/447
USPC 277/412

(57) ABSTRACT

A shaft seal arrangement for turbomachine is presented. The arrangement has a high and a low pressure side at each axial end, a rotor and a fixed stator part, and a dry gas seal. An additional shaft seal is provided at end of high-pressure side in a serial to seal intermediate space and has a fixed and a rotating shaft seal part. A central shaft seal surface extends in circumferential and in axial direction and is arranged between fixed and rotating shaft seal part on a fifth diameter coaxially with respect to rotational axis. A fourth stationary seal is arranged between fixed seal element and stator part on a fourth diameter to seal a first differential pressure. Damage due to changes of thrust is prevented if the dry gas seal is defective by difference between the fourth and fifth diameter being less than 10% of the firth diameter.

### CROSS REFERENCE TO RELATED APPLICATIONS

This application is the US National Stage of International Application No. PCT/EP2012/055274 filed Mar. 26, 2012 and claims benefit thereof, the entire content of which is hereby incorporated herein by reference. The International Application claims priority to the German application No. 10 2011 007 073.7 filed Apr. 8, 2011, the entire contents of which is hereby incorporated herein by reference.

### FIELD OF INVENTION

The invention refers to a shaft seal arrangement for a shaft seal of a turbomachine.

### BACKGROUND OF INVENTION

Dry gas seals are increasingly favored as shaft seals in turbomachines, for example in turbocompressors. Dry gas seals in the sense of the present invention are shaft seals which have at least two sealing elements which extend around the shaft in the circumferential direction (with regard to the rotational axis) and comprise in each case at least one sealing surface pointing towards the oppositely disposed sealing element, by means of which the dry gas seal seals the gap between a stationary part, for example a housing, and the rotating part. The sealing elements, by their annular sealing surfaces, as a rule face each other in a circumferentially and radially extending sealing plane. One of the sealing elements rotates with the rotating part and the other sealing element is at rest relative to the housing. At least one of the mutually facing sealing surfaces has surface projections and/or recesses which, interacting with a seal gas, ensure the build up of a gas film between the two sealing elements on the sealing surfaces so that the dry gas seal operates in a contact free manner between the rotating sealing element and the stationary sealing element during the provided rotation. The dry gas seal, in order to perform sealing in a damage free or contact free manner, needs a seal gas which basically has no liquid constituents. The recesses or projections can have various shapes and are preferably provided on only one sealing surface, preferably on the sealing surface of the rotating sealing element. Recesses can be, for example, of a U-shaped design or “fir tree” design or T-shaped design, or be designed in the manner of a spiral so that it leads to a forming of a stable sealing film of the seal gas between the two sealing surfaces.

Important advantages ensue by using dry gas seals on compressors, for example, by the leakage being comparatively low and by no lubricating oil being required, as, for example, in the case of seals with operate with liquids. Dry gas seals are regularly acted upon by the seal gas on a high-pressure side, wherein a small leakage of this seal gas passes through the dry gas seal from the high-pressure side to a side of lower pressure—a low-pressure side—where as a rule a discharge of this leakage into a so-called vent line or flare line is carried out. In order to reduce the consumption of the specially processed seal gas, the dry gas seal is routinely encompassed by other shaft seals. In particular, a labyrinth seal is routinely located on the high-pressure side and reduces the discharge of the seal gas to the side on the high-pressure side which faces away from the dry gas seal. A process gas, which in the case of a turbocompressor is under a higher operating pressure, is as a rule on the high-pressure side of the dry gas seal. The seal gas has to have an overpressure in relation to this process gas in order to keep the potentially contaminated process gas away from the sensitive dry gas seal.

### SUMMARY OF INVENTION

Starting from the described prior art, the invention is based on the task of damage to the dry gas seal having as little effect as possible upon the thrust on the rotor, in relation to the shaft of which the dry gas seal provides sealing.

The shaft seal arrangement for a shaft seal of a turbomachine extends in an axial direction along a rotational axis,

wherein the shaft seal arrangement has a high-pressure side at one axial end and a low-pressure side at the other axial end, comprising:

a rotor part which rotates during operation,

a stationary stator part,

at least one dry gas seal which has a rotating sealing element attached to the rotor part and a stationary sealing element attached to the stator part for sealing a gap between the rotor part and the stator part against a first differential pressure,

wherein the stationary sealing element and the rotating sealing element are arranged opposite each other on a sealing surface which extends radially and in the circumferential direction,

wherein on the end of the high-pressure side of the shaft seal arrangement provision is made in a series arrangement in relation to the dry gas seal for a labyrinth seal which is for sealing the gap and comprises a stationary part and a rotating part,

wherein a center labyrinth sealing surface which extends in the circumferential direction and axial direction is arranged on a fifth diameter coaxially to the rotational axis between the stationary labyrinth seal part and the rotating labyrinth seal part,

wherein between the stationary sealing element and the stator part a fourth stationary seal is arranged on a fourth diameter for sealing against the first differential pressure.

The invention with a shaft seal arrangement with the additional features of the independent claim offers a solution for this first-named object. The dependent claims comprise advantageous developments of the invention.

Within the conceptual scope of the invention, the rotational axis is a central axis of the shaft seal arrangement, which is referred to as the rotational axis, since in the case of the dry gas seal of the shaft seal arrangement it is a shaft seal which naturally encompasses a shaft which rotates during operation. All specifications, without further explanation, in relation to the conceptual scope of such a circular movement—for example axial, radial, circumferential direction, and diameter—refer to the rotational axis as the center of a rotational movement.

The conceptual scope furthermore differentiates between two basically different seal types, namely the shaft seal, which seals two components in relation to each other which are in motion relative to each other, and the stationary seal, which seals two components in relation to each other which are at rest relative to each other.

With reference to the shaft seal according to the invention, the terms high-pressure side and low-pressure side are used, which in other words means that the shaft seal, against a pressure difference, prevents or reduces a crossover of fluid from a side of higher pressure to a side of lower pressure and consequently maintains the pressure difference.

The invention displays particular advantages in the case of a differential pressure across the shaft seal arrangement according to the invention which amounts to more than 200 bar. It is particularly expedient when the circumferentially and radially extending sealing surface between the stationary labyrinth seal part and the rotating labyrinth seal part on the fifth diameter coaxially to the rotational axis is basically identical to a fourth diameter upon which a fourth stationary seal is located between the stator part and the stationary sealing element of the dry gas seal because a larger deviation from this geometric requirement can induce high forces on a thrust bearing if the dry gas seal has a defect. Preferably, the difference between the fourth diameter and the fifth diameter is less than 10% of the fifth diameter.

In the manner according to the invention, an only comparatively small change of the thrust upon a shaft of a turbomachine takes place in the case of a defect of the dry gas seal of the shaft seal arrangement according to the invention since the diameters upon which the different pressures—which differ as a result of the differential pressure across the dry gas seal—bear on the rotor, do not differ in the case of a reduction across the dry gas seal itself from the case in which the differential pressure across the associated labyrinth seal is reduced.

Particularly in the case of a compressor with a dry gas seal which reduces a pressure differential of over 200 bar in the normal operating state, a thrust bearing as a rule is not in the position to suffer the thrust change if the dry gas seal has a defect and a change of the shaft thrust results therefrom, should the previously defined criteria with regard to the diameters not be fulfilled.

So that the sealing elements of the dry gas seal of the shaft seal arrangement do not suffer unnecessarily high loads and ensure the necessary geometry for building up the lubricating film between the sealing surfaces which creates the freedom of contact, it is expedient if a third stationary seal between the rotor part and the rotating sealing element is arranged on a third diameter and if the third diameter differs from the fourth diameter by not more than 10% of the fourth diameter.

The design according to the invention is especially advantageous for shaft seal arrangements in which the stationary sealing element of the dry gas seal is sealed in relation to the stator part by means of a fourth stationary seal on a fourth diameter and a center labyrinth seal surface which extends in the circumferential direction and axial direction is arranged between the stationary labyrinth seal part and the rotating labyrinth seal part on a fifth diameter coaxially to the rotational axis, wherein the fifth diameter is smaller than, or equal to, the fourth diameter.

Another object is the reduction of the complexity of a turbomachine which has a shaft seal arrangement of the type described in the introduction, wherein the assembly of such a turbomachine can be simplified and the space requirement of the shaft seal arrangement can be reduced.

The stator part, which is already mentioned in the introduction, is to be understood as a stationary component which is preferably a carrier of components of at least the dry gas seal of the shaft seal arrangement.

The stator part is preferably designed as a stator sleeve for the shaft seal arrangement and can be inserted into a recess of a stator which is preferably formed as a housing of the turbomachine. In this case, it may also involve components which are connected to the housing so that an indirect connection of the stator part to a housing of a turbomachine is provided. In any case, the stator part in a design as a stator sleeve is suitable for assembling the constructional elements of the shaft seal arrangement in a unit so that the shaft seal arrangement is a separately movable module which within the scope of the assembly can be attached en bloc on the shaft of a rotor. Preferably, the shaft seal arrangement according to the invention is first of all attached on the shaft and then together with the shaft is introduced into, for example, a barrel-type casing or inserted in a lower casing half and fastened in the housing.

Particular advantages ensue by a design of the shaft seal arrangement with a stator sleeve and a rotor sleeve—which are both carriers of the labyrinth seal in each case—on account of the reduction of the complexity as a result of the reduction of the number of parts of a turbomachine since the labyrinth seal which is adjacent to the dry gas seal of the shaft seal arrangement is therefore a component part of the shaft seal arrangement. The advantage of the simplification is especially significant within the scope of the assembly since only a single module has to be attached on the shaft and the complex alignment operations of a rotor in relation to the shaft seal arrangement and the labyrinth seal installation which conventionally is arranged separately from this are greatly simplified or partially dispensed with. In the prior art, partially difficult and time-consuming alignments had to be carried out, especially alignments of the components of the rotor, dry gas seal, labyrinth seal or housing in relation to each other. On account of combining the labyrinth seal with the dry gas seal in the preferred shaft seal arrangement, it is furthermore possible to reduce the installation space of a shaft seal of a turbomachine, especially because the labyrinth seal no longer requires a separate fastening on the housing but is fastened together with the shaft seal arrangement directly on said housing. This saving of space leads especially to a lower requirement for axial installation space, which lowering enables a reduction of the required length of the shaft of the rotor, as a result of which important rotor-dynamic advantages accrue, especially vibration amplitudes occurring less and any resonance frequencies advantageously increasing as a result of the stiffening. In the case of otherwise the same operating parameters of a turbomachine, this enables a reduction of the shaft diameter so that with the assumed same radial clearance requirement a smaller area is to be sealed by means of the shaft seal so that an only smaller potential leakage volume results and the efficiency of the turbomachine is increased.

The arrangement of the labyrinth seal on the high-pressure side as the axially outermost shaft seal is expedient so that it is ensured that no contaminants from the high-pressure side can make their way unhindered to the dry gas seal of the shaft seal arrangement. The shaft seal arrangement on the stator part is expediently provided with a second stationary seal so that the stator part can be inserted with sealing effect in a recess of the stator. Furthermore, the rotor part is expediently provided with a stationary seal so that the rotor part can be attached with sealing effect to the shaft of a rotor. The shaft of the rotor can advantageously be provided with a shoulder on which the rotor part comes to bear axially by a contact surface. In the case of the stationary seals between the shaft and the rotor part, or between the stator recess and the stator part, they are, for example, seals with a V-shaped cross section (PTFE cup seals) which under a pressure differential expand in such a way that the sealing effect is boosted.

The invention refers not only to a shaft seal arrangement but also to a turbomachine comprising a shaft seal arrangement according to the invention, at least one housing and a rotor with a shaft.

An advantageous development of the invention expediently has a feed line of a seal gas between the labyrinth seal and the dry gas seal of the shaft seal arrangement into the axial gap so that the labyrinth seal reduces a discharge of the processed and clean seal gas in the direction of the high-pressure side and the dry gas seal is exposed only to the admission of the clean seal gas. To this end, the seal gas, in relation to a process gas on the other side of the labyrinth seal, is expediently in an overpressure on the high-pressure side so that no proportion of the process gas can reach the dry gas seal. On the low-pressure side of the dry gas seal, provision is expediently made for a seal drain which directs the clean seal gas, possibly as a mixture with another gas which is present on the low-pressure side, to a seal gas processing plant or to a flare.

The advantageous design of the stationary labyrinth seal part and of the rotating labyrinth seal part as parts of the stator part or of the rotor part is to be understood in such a way that an at least partially one-piece design of these two constructional elements in each case is also included. Both the rotating part and the stationary part of the labyrinth seal can have peaks, wherein it may involve a genuine labyrinth or a see-through labyrinth. A releasable fastening, which especially can be provided alternatively to the at least partial one-piece design, is to be understood by the fixed attachment according to the invention of the labyrinth seal parts on the stator part and rotor part which are possibly formed as sleeves.

### BRIEF DESCRIPTION OF DRAWINGS

The invention is explained in more detail in the following text based on exemplary embodiments with reference to drawings, wherein possibilities of the embodiment of the invention which deviate from the exemplary embodiments are revealed to the person skilled in the art from especially any combination of the claims. In the drawing:

FIGS. 1-3 show in each case a longitudinal section through a shaft seal arrangement according to the invention.

### DETAILED DESCRIPTION OF INVENTION

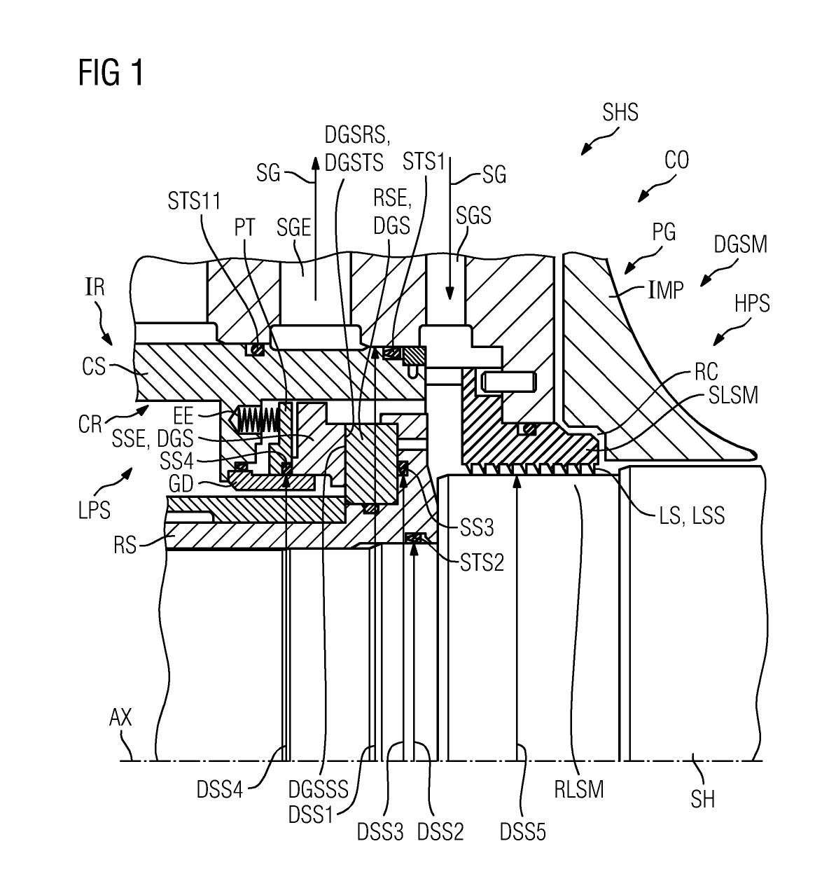

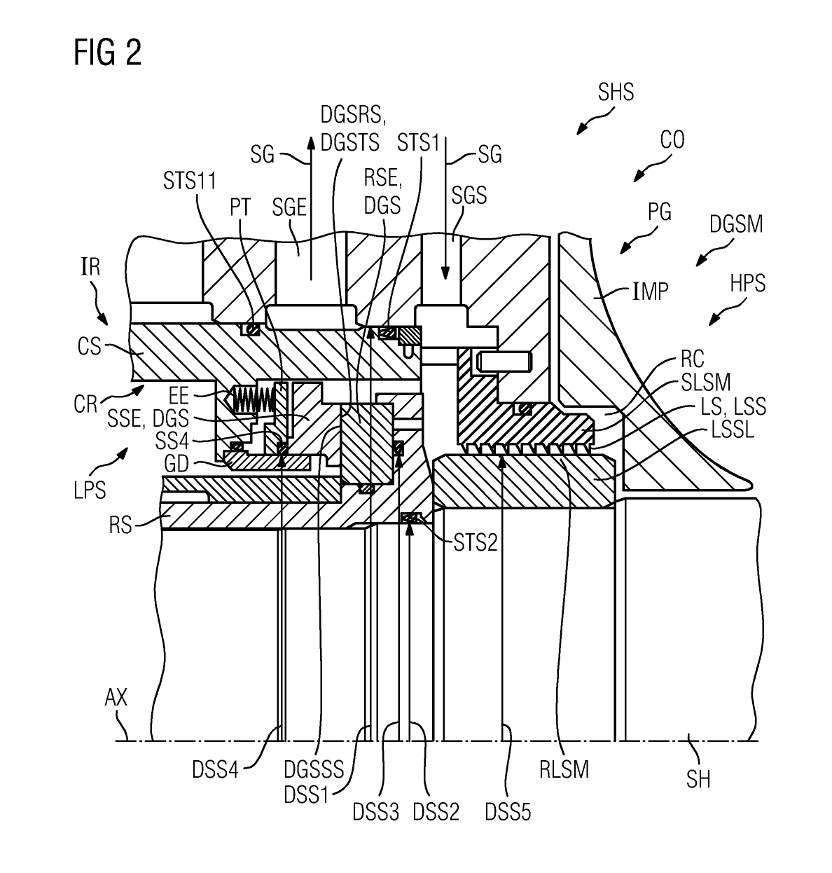

In the following description, identical constructional elements or constructional elements with identical functions are provided with the same designations. Terms such as axial, radial, circumferential direction, diameter and radius relate to a rotational axis AX which is a central axis of a shaft seal arrangement DGSM according to the invention. The shaft seal arrangement DGSM which is shown in FIGS. 1 and 2 comprises a stator part CS and a rotor part RS and also a dry gas seal DGS and a labyrinth seal LS. The rotor part RS of the shaft seal arrangement DGSM is attached with sealing effect on a shaft SH of a rotor R by means of a second static seal STS2 on a diameter DSS2. The shaft SH is equally a carrier of at least one rotor wheel—which is not shown—of a turbomachine CO which is designed as a centrifugal compressor in a way which is not shown in more detail.

The stator part CS is inserted with sealing effect into a stator recess CR by means of a first stationary seal STS1 on a first diameter DSS1. The first stationary seal STS1 and the second stationary seal STS2 have a V-profile which is arranged in a respective circumferentially extending seal groove in such a way that the V-profile expands if an application of pressure on the stationary seal from a high-pressure side HPS is carried out. The shaft seal arrangement DGSM has an axial high-pressure side HPS and an axial low-pressure side LPS, wherein the high-pressure side HPS is exposed to a process gas PG which is under an overpressure in relation to the low-pressure side LPS. The stator part CS is additionally sealed in relation to the stator recess CR by an O-ring seal STS11. The shaft seal arrangement DGSM in FIGS. 1, 2, 3 is a component part of a shaft seal SHS which is not shown in its entirety.

A gap IR between the stator part CS and the rotor part RS is sealed by means of the dry gas seal DGS on one side and, in a series arrangement therewith, by the labyrinth seal LS on the other side. The dry gas seal DGS in this case serves for the principal reduction of the pressure difference between the high-pressure side HPS and the low-pressure side LPS. Between the dry gas seal DGS and the labyrinth seal LS provision is made for a seal gas feed line SGS of a particularly clean seal gas SG. The function of the labyrinth seal LS is in this case the reduction of the discharge of the seal gas SG in the direction of the high-pressure side or into the potentially contaminated and chemically aggressive process gas PG. The dry gas seal DGS is therefore exposed to the admission of only the clean and dry seal gas SG on the high-pressure side, which has an overpressure in relation to the process gas PG. On the low-pressure side LPS of the dry gas seal DGS, provision is made for a seal gas discharge line SGE of the only small leakage of the dry gas seal DGS, which discharge line leads into a vent or a flare, which are not shown.

The dry gas seal DGS has a rotating sealing element RSE and a stationary sealing element SSE which by a respective sealing surface are oppositely disposed on a common dry gas seal sealing surface DGSSS. The rotating sealing element RSE is sealed in relation to the rotor part RS against the differential pressure by means of a third stationary seal SS3 which extends in the circumferential direction on a third diameter DSS3. The stator part CS has an elastic element EE which by means of a guide GD and a piston PT pretensions the stationary sealing element SSE against the rotating sealing element RSE. The stationary sealing element SSE is sealed in relation to the piston PT against the differential pressure by means of a fourth stationary seal SS4 on a fourth diameter DSS4. Within the conceptual scope of the invention, the elastic element EE and the piston PT and also a guide GD are added to the stator part CS.

The labyrinth seal LS has a stationary seal part SLSM and a rotating seal part RLSM which lie opposite each other on an axially and circumferentially extending center labyrinth seal surface LSS, wherein the center labyrinth seal surface LSS extends in the circumferential direction on a fifth diameter DSS5. To be understood by the center labyrinth seal surface is a surface which extends axially and circumferentially along the constant fifth diameter DSS5 is, wherein the fifth diameter is the result of a circular surface-weighted averaging of the high-pressure-side outside diameter, the high-pressure-side inside diameter, the low-pressure-side outside diameter, and the low-pressure-side inside diameter of the opening of the labyrinth seal LS.

The rotating sealing element RSE lies opposite the stationary sealing element SSE on the dry gas seal surface DGSSS by a rotating sealing surface DGSRS which is provided with projections and recesses which are preferably wedge-shaped and/or spiral-shaped. The stationary sealing element SSE points to a stationary sealing surface DGSTS which faces the dry gas seal sealing surface DGSSS and is adapted to the forming of the opposite rotating sealing surface DGSRS in such a way that a contactless operation of the dry gas seal DGS, by the forming of a corresponding lubricating film of the seal gas SG, is ensured.

According to the invention, in all three exemplary embodiments a specific suitability is provided for the high-pressure application in the case of differential pressures of over 200 bar. The labyrinth seal surface LSS is located on a basically identical fifth diameter DSS5 to the fourth stationary seal SS4 between the rotor part RS and the rotating sealing element RSE, or the difference between the fifth diameter DSS5 and the fourth diameter DSS4 is less than 10% of the fifth diameter DSS5.

Furthermore, for minimizing mechanical load on the sealing elements of the dry gas seal DGS the difference between the third diameter DSS3 and the fourth diameter DSS4 is less than 10% of the third diameter DSS3 or, alternatively, less than 10% of the fourth diameter DSS4. In this case, the respective proximity of the fifth diameter DSS5, fourth diameter DSS4 and third diameter DSS3 is of importance, wherein the proximity of the fifth diameter DSS5 to the fourth diameter DSS4 has priority.

FIG. 1 shows a two-part design of the shaft seal arrangement DGSM, in which the dry gas seal DGS is attached on the shaft SH as a modular unit comprising the stator part CS and the rotor part RS. Basically independently thereof, the rotating labyrinth seal element RLSM is formed as a shaft shoulder which adjoins the shaft section on which is attached the rotor part RS. The stationary part of the labyrinth seal SLSM is fixedly connected to a shoulder on the stator recess CR and consequently connected only indirectly to the stator part CS.

FIG. 2 shows a design of the shaft seal arrangement DGSM according to the invention which is especially suitable as a retrofit solution. A labyrinth seal LS, which originally was possibly not arranged with the diameter configuration according to the invention, is comparable with the stationary labyrinth seal part SLSM as is fastened on a shoulder of the stator recess CR in FIG. 1. The rotating part of the shaft seal RLSM is designed as a sleeve SL which increases the diameter of the shaft and is specifically dimensioned in such a way that the diameter parameters according to the invention exist on the dry gas seal DGS and on the labyrinth seal LS. Such a configuration is of interest not only as a retrofit solution but also advantageous in so far as the diameter of the dry gas seal DGS which is larger on both sides in relation to the encompassing shaft SH, especially the fourth diameter DSS4, does not have to inevitably lead constructionally to a large shoulder of the shaft SH, which in turn necessitates large rotor wheel diameters by which the rotor R can be attached. Instead, a sleeve SL, which increases the diameter of the shaft SH in the region of the labyrinth seal LS, is provided as the rotating sealing element RLSM of the labyrinth seal LS. The diameter increase by means of this sleeve SL can be flexibly adapted to the remaining constructional data of the turbomachine.

In addition, it is possible, as shown in FIGS. 1 to 3, that the flow-guiding contour IMP has a recess RC close to the shaft, in which an axial section of the shaft seal arrangement DGSM is arranged. In this way, the shaft SH is shortened to the advantage of the rotor dynamics so that the vibrations which are to be taken into consideration turn out to be less and the radial clearances can be of smaller dimensions to the benefit of increased efficiency.

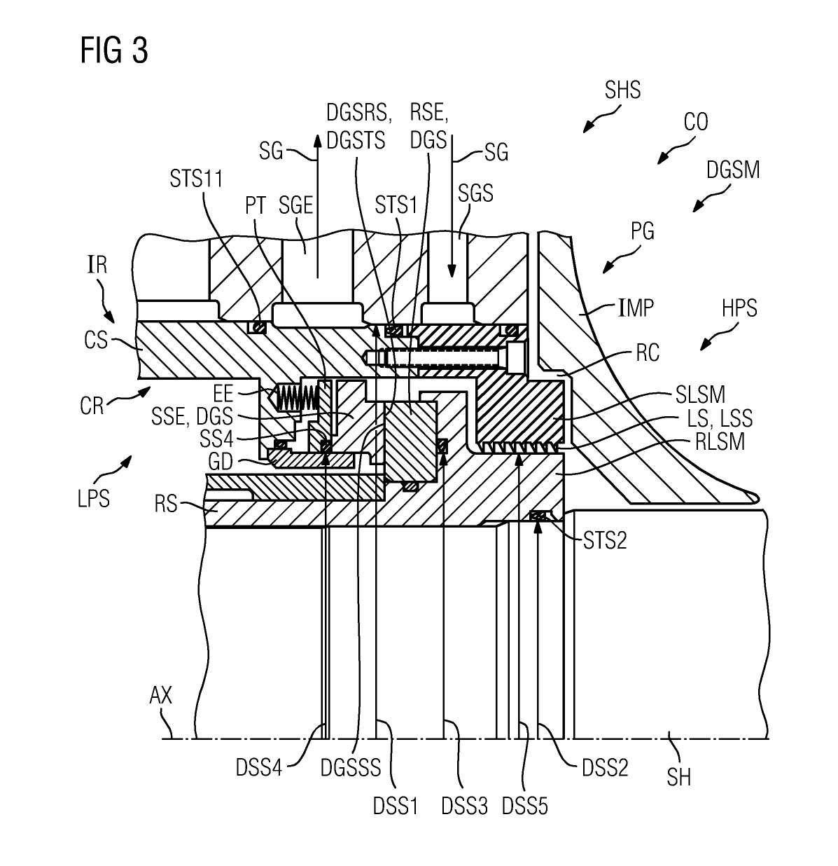

In addition, axial installation space can be saved with the design shown in FIG. 3 if the rotating part RLSM and the stationary part SLSM of the labyrinth seal LS are a fixed component part in each case of the rotor part RS and of the stator part CS or are fixedly attached to these.

In addition, this single-module type of construction saves on assembly cost and alignment cost during the assembly since the one-piece shaft seal arrangement DGSM of this type can already be aligned in advance.

1.-8. (canceled)

9. A shaft seal arrangement for a shaft seal of a turbomachine extending in an axial direction along a rotational axis, comprising:
a high-pressure side at one axial end;
a low-pressure side at the other axial end;
a rotor part that rotates during an operation;
a stationary stator part;
at least one dry gas seal comprising a rotating sealing element attached to the rotor part and a stationary sealing element attached to the stator part for sealing a gap between the rotor part and the stator part against a first differential pressure, wherein the stationary sealing element and the rotating sealing element are arranged opposite to each other on a sealing surface extending radially and in a circumferential direction; and
a further additional shaft seal provided on an end of the high-pressure side in a series arrangement in relation to the dry gas seal for sealing the gap, the additional shaft seal comprising a stationary shaft seal part and a rotating shaft seal part,
wherein a center shaft seal surface extending in the circumferential direction and the axial direction is arranged between the stationary shaft seal part and the rotating shaft seal part on a fifth diameter coaxially to the rotational axis,
wherein a fourth stationary seal is arranged between the stationary sealing element and the stator part on a fourth diameter for sealing against the first differential pressure, and
wherein a difference between the fourth diameter and the fifth diameter is less than 10% of the fifth diameter.

10. The shaft seal arrangement as claimed in claim 9, wherein the further additional shaft seal is a labyrinth seal, wherein the stationary shaft seal part is a stationary labyrinth seal part, wherein the rotating shaft seal part is a rotating labyrinth seal part, and wherein the center shaft sealing surface is a center labyrinth seal surface.

11. The shaft seal arrangement as claimed in claim 10, wherein the stationary labyrinth seal part is a part of the stator part or is fixedly attached to the stator part, and wherein the rotating labyrinth seal part is a part of the rotor part or is fixedly attached to the rotor part.

12. The shaft seal arrangement as claimed in claim 10, wherein the labyrinth seal is an axially outermost seal of the shaft seal arrangement on the high-pressure side.

13. The shaft seal arrangement as claimed in claim 10, wherein the gap comprises a seal gas feed line axially between the labyrinth seal and the dry gas seal for directing a seal gas, and wherein the shaft seal arrangement further comprises a seal gas discharge line on a side of the dry gas seal facing the low-pressure side for discharging the seal gas that passes through the dry gas seal.

14. The shaft seal arrangement as claimed in claim 9, wherein the rotor part comprises a rotor sleeve that can be attached on a shaft of a rotor that extends along the rotational axis.

15. The shaft seal arrangement as claimed in claim 9, wherein the stator art comprises a stator sleeve that can be inserted into a stator recess.

16. The shaft seal arrangement as claimed in claim 9, wherein the stator part comprises a first stationary seal that can be inserted with a sealing effect into a stator recess, and/or wherein the rotor part comprises a second stationary seal that can be attached with the sealing effect on a shaft.
